(19) United States
(12) Patent Application Publication
(10) Pub. No.: US 2025/0290595 A1
(43) Pub. Date: Sep. 18, 2025

(54) SUPPORT METHOD OF SUPPORT STRUCTURE AND SUPPORT STRUCTURE

(71) Applicant: XinY Structural Consultants, Shanghai (CN)

(72) Inventors: Yuan Xin, Shanghai (CN); Xinwei Tao, Shanghai (CN); Xixi Li, Shanghai (CN); Fei Chen, Shanghai (CN)

(21) Appl. No.: 18/835,816

(22) PCT Filed: Jan. 17, 2023
(86) PCT No.: PCT/CN2023/072727

§ 371 Date: Aug. 5, 2024

(30) Foreign Application Priority Data
Dec. 5, 2022 (CN) 202211551781.4

(51) Int. Cl. F16M 11/04; F16M 11/20

(52) U.S. Cl. CPC F16M 11/04; F16M 11/20

(57) ABSTRACT

The disclosure provides a support method of a support structure, and a support structure, which can reduce external thermal stress. In the support method, a connection point is arranged on a supported body, an end of a rod is arranged at the connection point, the other end is arranged at a support, and a position of the support is selected according to the following relation: as for a projection point (Pᵢa) perpendicularly projected from the support (200) onto a line connecting a pre-temperature change position (Pᵢ) and a post-temperature change position (P′ᵢ) of the connection point, a ratio (Δa/Δ) of a distance (Δa) between the pre-temperature change position (Pᵢ) and the projection point (Pᵢa) to a distance (Δ) between the pre-temperature change position (Pᵢ) and the post-temperature change position (P′ᵢ) falls within a predetermined range.

### TECHNICAL FIELD

The disclosure relates to a support method of a support structure, and a support structure, and more particularly, it relates to a method for supporting by a support structure in a temperature field, and a support structure.

### BACKGROUND

In construction, machinery, marine, power, aerospace and other fields, thermal stress is generated in an object when expansion or contraction caused by a temperature change is restrained.

For example, in the case that an engine is subjected to a large temperature difference, despite a small geometric dimension of the engine, a large thermal stress and thermal strain are generated accordingly due to the constraint of the engine case. Therefore, in engine design, a fixed hinged support is typically located in a non-high-temperature region.

Furthermore, for example, in the field of civil engineering, a large structure typically has strong statically indeterminate boundary constraints to resist wind, seismic forces, etc. As for thermal stress and strain generated by an environmental temperature difference, at present, the thermal stress of a structure is typically released by providing a deformation joint (temperature joints).

### SUMMARY

### Problem to be Solved by the Disclosure

However, in a case that only a limited number of fixed hinged supports can be set in a non-high-temperature region in engine design, when an engine is in a high temperature state, the fixed hinged supports bear a large concentrated force, such that requirements for materials, strength, durability, etc. of the fixed hinged supports are very high.

Moreover, in a case of using a deformation joint in civil engineering, the deformation joint leads to structural discontinuity, such that repeated members need to be arranged to form a plurality of independent structural systems. As a result, not only the number of parts increases and the cost increases, but also the deformation joint has problems of water leakage and influencing the appearance.

Furthermore, similar problems also exist in the fields of gas turbines and electric power engineering due to a temperature difference.

### Means for Solving Problems

Generally, thermal stress in a temperature changing field consists of two parts: one part is generated due to a change of a temperature of each internal point or a difference of materials constituting an object without external constraints (referred to as internal thermal stress); and the other part is additional stress (referred to as external thermal stress) generated by a thermally deformed object subjected to external constraints. After thorough research and repeated mathematical analysis, the inventor of the present disclosure obtains that the external thermal stress can be reduced by reasonably arranging a rod and a support thereof. Accordingly, the inventor of the present disclosure provides a support method of a support structure. The method includes: arranging a connection point on a supported body, arranging an end of a rod at the connection point, arranging the other end at a support, and selecting a position of the support according to the following relation: as for a projection point perpendicularly projected from the support onto a line connecting a pre-temperature change position and a post-temperature change position of the connection point, a ratio of a distance between the pre-temperature change position and the projection point to a distance between the pre-temperature change position and the post-temperature change position falls within a predetermined range.

In the above technical solution, the predetermined range is preferably greater than or equal to −0.4 and less than or equal to 1.4, more preferably, greater than or equal to 0 and less than or equal to 1, and still more preferably, greater than or equal to 0.21 and less than or equal to 0.62.

Furthermore, preferably, an end of the rod is connected to the connection point, and more preferably, the support is a fixed hinged support.

The other aspect of the disclosure provides a support structure. The support structure includes a rod and a support. A connection point is arranged on a supported body, an end of the rod is connected to the connection point, the other end is supported on the support, and arranged positions of the support satisfy the following relation: as for a projection point perpendicularly projected from the support onto a line connecting a pre-temperature change position and a post-temperature change position of the connection point, a ratio of a distance between the pre-temperature change position and the projection point to a distance between the pre-temperature change position and the post-temperature change position falls within a predetermined range.

### Effect of the Disclosure

According to the support method of a support structure and a support structure in the disclosure, external thermal stress of an object can be reduced when a temperature of a temperature field changes, such that the number of parts and cost are reduced.

### BRIEF DESCRIPTION OF THE DRAWINGS

FIG. 1 is a schematic diagram of an arbitrary object M in a temperature field;

FIG. 2 is a time curve showing an internal force of an elastic rod;

FIG. 3 shows a curve of a preferred relation between Δa/Δ and an elastic rod axial force amplitude value;

FIG. 4 is a graph showing a relation between Δa/Δ and an elastic rod axial force amplitude value in a specific instance; and

FIG. 5 is a schematic diagram showing a case that a supported body is provided with a plurality of connection points.

### DETAILED DESCRIPTION

Embodiments of the disclosure will be described in detail with reference to the accompanying drawings hereinafter.

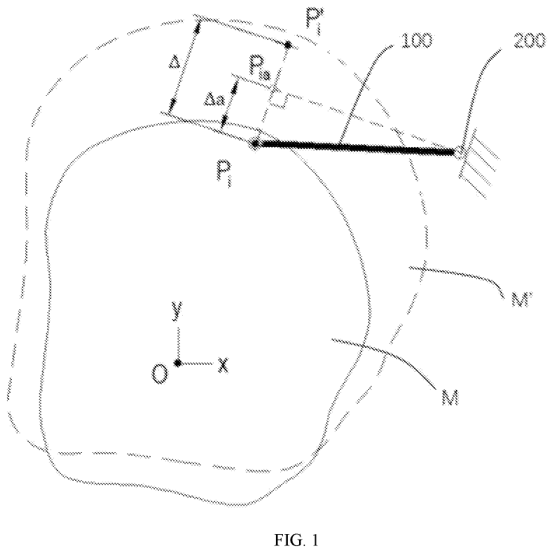

FIG. 1 is a schematic diagram of an arbitrary object M (also referred to as a supported body) in a temperature field. In FIG. 1, a solid line shows the object M before the temperature field changes, that is, before a temperature change. A dotted line shows an object M′ after the temperature field changes, that is, after the temperature change. An end of a rod 100 is connected to a connection point (point Pᵢ in FIG. 1) on the object M, and the other end of the rod 100 is connected to a support 200. It should be noted that the rod is not particularly limited herein, and may be an elastic rod capable of elastic deformation, an elastic-plastic rod capable of elastic-plastic deformation, a chain rod, etc. Moreover, a position of the connection point on the object M is not limited, and those skilled in the art should know that the connection point is any point on the object M.

As described above, the inventor of the present disclosure proposes that external thermal stress can be effectively reduced by appropriately setting the position of the support 200. For convenience of explanation, a case that the rod 100 is an elastic rod, an end of the rod is hinged to the point Pᵢ, and the support 200 at the other end is a fixed hinged support is described as an instance.

With reference to FIG. 1, in an XYZ right-hand rectangular coordinate system, the origin is set to O, an x direction is a rightward direction in the paper, a y direction is a vertical upward direction in the paper, and a z direction (not shown) is orthogonal to an xy plane. In the XYZ coordinate system, assuming that coordinates of the point Pᵢ on the object M are (xᵢ, yᵢ, zᵢ), the point Pᵢ is a pre-temperature change position of the connection point. After a temperature change, the object M is deformed to M′, and the point Pᵢ (xᵢ, yᵢ, zᵢ) is deformed to P′ᵢ (x′ᵢ, y′ᵢ, z′ᵢ), and the point P′ᵢ is a post-temperature change position of the connection point. Therefore, thermal deformation of the connection point before and after a temperature change Δ=|PᵢP′ᵢ| (that is, a distance between point Pᵢ and point P′ᵢ).

As shown in FIG. 1, the point Pᵢ is connected to the point P′ᵢ, and a perpendicular projection of the support 200 (that is, the other end of the rod 100) on a line PᵢP′ᵢ is a projection point Pᵢa. In other words, the projection point Pᵢa is an intersection point of a perpendicular line drawn perpendicularly from the support 200 to the line PᵢP′; and the line PᵢP′ᵢ. A distance from the point Pᵢ to the projection point Pᵢa is Δa=±|PᵢPᵢa|. A value of Aa is positive when the projection point Pᵢa is located on a side of the point P′ᵢ on the line PᵢP′ᵢ with respect to the point Pᵢ. The value of Δa is negative when the projection point Pᵢa is located on an opposite side of the point P′ᵢ on the line PᵢP′ᵢ with respect to the point Pᵢ. For simplicity of explanation, only a case that the value of Δa is positive is shown in FIG. 1, and the same is true for the case that the value of Δa is negative.

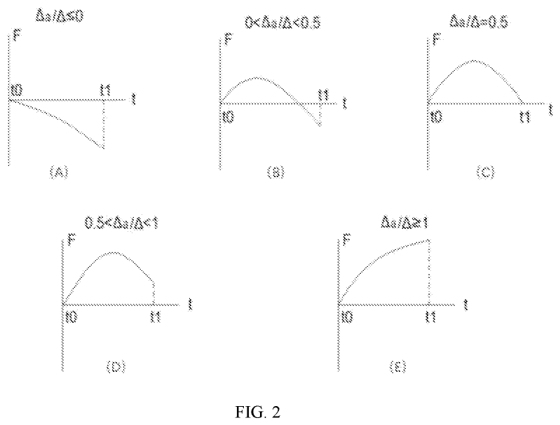

The inventor of the present disclosure obtains a time curve of an elastic rod internal force with different Δa/Δ values at a temperature change through a large amount of mathematical analysis. With reference to FIG. 2, FIGS. 2(A)-2(E) sequentially show curves of the elastic rod internal force F over time t when Δa/Δ≤0 (FIG. 2(A)), 0<Δa/Δ<0.5 (FIG. 2(B)), Δa/Δ=0.5 (FIG. 2(C)), 0.5<Δa/Δ<1 (FIG. 2(D)), and Δa/Δ≥1 (FIG. 2(E)).

In detail, from moment t0 to moment t1, the object M thermally deforms into the object M′ according to a temperature field change, and the point Pᵢ thermally deforms to the point P′ᵢ.
(1) In a case that Δa/Δ≤0,
as shown in FIG. 2(A), an internal force of the rod 100 gradually increases from 0 as the point Pᵢ thermally deforms towards the point P′ᵢ, and reaches a maximum value when the point Pᵢ thermally deforms to the point P′ᵢ.
(2) In a case of 0<Δa/Δ<0.5,
as shown in FIG. 2(B), the internal force of the rod 100 gradually increases from 0 as the point Pᵢ thermally deforms towards the point P′ᵢ, reaches a maximum value when the rod 100 is orthogonal to the line PᵢP′ᵢ, and then gradually decreases. After decreasing to 0, the internal force of the rod 100 changes to an opposite direction and gradually increases again.
(3) In a case that Δa/Δ=0.5,
as shown in FIG. 2(C), the internal force of the rod 100 gradually increases from 0 as the point Pᵢ thermally deforms towards the point P′ᵢ, reaches a maximum value when the rod 100 is orthogonal to the line PᵢP′ᵢ, and then gradually decreases. When the point Pᵢ thermally deforms to the point P′ᵢ, the internal force decreases to 0.
(4) In a case that 0.5<Δa/Δ<1.0,
as shown in FIG. 2(D), as the point Pᵢ thermally deforms towards the point P′ᵢ, the internal force of the rod 100 gradually increases from 0 and then decreases. Moreover, when the rod 100 is perpendicular to a deformation direction, its internal force reaches a maximum value.
(5) In a case that Δa/Δ≥1.0, as shown in FIG. 2(E), an internal force of the rod 100 gradually increases from 0 as the point Pᵢ thermally deforms towards the point P′ᵢ, and reaches a maximum value when the point Pᵢ thermally deforms to the point P′ᵢ.

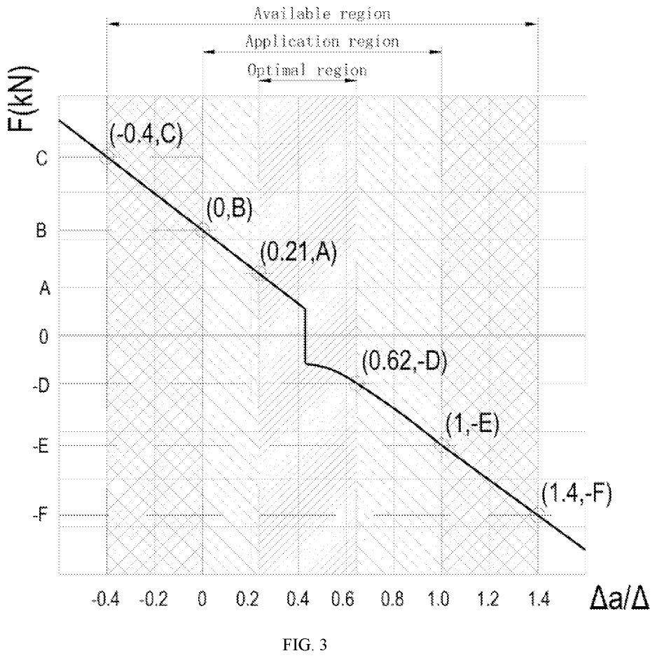

Based on results of the above mathematical analysis, the inventor of the present disclosure concluded that by setting Δa/Δ within a predetermined range, an excellent effect of effectively reducing external thermal stress can be achieved, which will be described in detail below with reference to FIG. 3.

FIG. 3 shows a curve of a relation between Δa/Δ and an elastic rod axial force amplitude value in a specific embodiment. In FIG. 3, a horizontal axis is a setting position Δa/Δ of the fixed hinged support 200, and a vertical axis is an elastic rod axial force amplitude value F (with a unit of kN). That is, the curve in FIG. 3 shows an axial force amplitude value of the elastic rod when the position of the fixed hinged support 200 is set to make Δa/Δ have different values during a temperature field change. As shown in FIG. 3, six characteristic points (−0.4, C), (0, B), (0.21, A), (0.62, −D), (1, −E) and (1.4, −F) are marked on the curve in sequence from a left side. A, B, C, −D, −E and −F represent elastic rod axial force amplitude values corresponding to specific A a/A respectively. As shown in FIG. 3, a range where the abscissa A a/A is greater than or equal to −0.4 and less than or equal to 1.4 is denoted as “available region”. The external thermal stress can be effectively reduced by arranging the fixed hinged support 200 in the available area. Δ a/Δ is more preferably set to a range of being greater than or equal to 0 and less than or equal to 1 (referred to as “application region” with reference to FIG. 3). Most preferably, Δ a/Δ is set to a range of being greater than or equal to 0.21 and less than or equal to 0.62 (referred to as “optimal region” with reference to FIG. 3). By setting the fixed hinged support 200 in the application region or the optimal region, the effect of reducing the external thermal stress can be further achieved accordingly.

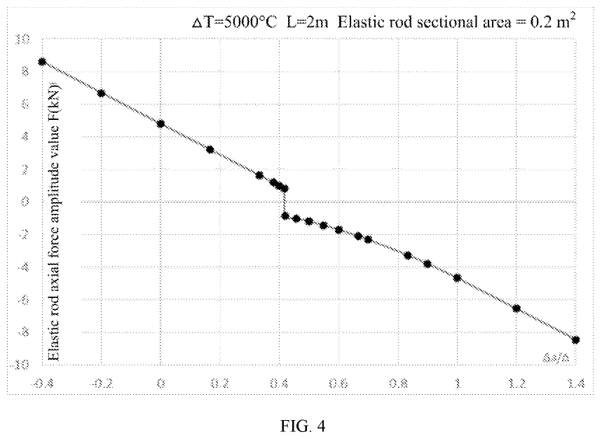

Furthermore, FIG. 4 is a graph showing numerical results obtained based on a specific simulation instance. In FIG. 4, similarly to FIG. 3, a horizontal axis is a setting position Δa/Δ of the fixed hinged support 200, and a vertical axis is an elastic rod axial force amplitude value F (with a unit of kN). In the specific instance, a temperature change is, for example, ΔT=5000° C. The elastic rod has a rod length L of 2 m and a sectional area of 0.2 m². As shown in FIG. 4, based on results of nonlinear analysis, Δa/Δ falls within the range of −0.4 to 1.4, the elastic rod axial force amplitude value can be suppressed within an allowable range.

Based on the above studies, the inventor of the present disclosure proposes a support method using a rod, which can reduce external thermal stress by reasonably setting the support of the rod.

Specifically, an end of the rod 100 is hinged to a connection point on an object, and the other end is supported on the support 200. As for a projection point Pᵢa perpendicularly projected from the support 200 onto a line connecting a pre-temperature change position Pᵢ and a post-temperature change position P′ᵢ of the connection point, a ratio Δa/Δ of a distance Δa between the pre-temperature change position Pᵢ and the projection point Pᵢa to a distance Δ between the pre-temperature change position Pᵢ and the post-temperature change position P′ᵢ falls within a predetermined range, preferably being greater than or equal to −0.4 and less than or equal to 1.4, more preferably being greater than or equal to 0 and less than or equal to 1, and still more preferably being less than or equal to 0.21 and less than or equal to 0.62.

By setting the ratio Δa/Δ as the range, the external thermal stress of the object can be reduced, and the problems of large concentrated stress and high design difficulty of a fixed hinged support, discontinuous structure and large number of parts caused by deformation joints, etc. in the prior art can be solved.

Furthermore, in the above example of FIG. 3, the temperature field change ΔT=5000° C. has been described as an example, but the disclosure can actually be applied to any temperature field change that may cause external thermal stress.

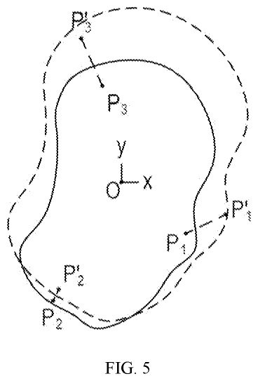

Moreover, the above describes a case that only one connection point is provided. However, the number of the connection points is not limited herein, and two or more connection points may be provided as needed. For example, FIG. 5 shows a case that three connection points are considered. By hinging three rods at points P₁, P₂ and P₃ respectively, fixed hinge supports are arranged at appropriate positions based on post-temperature change positions, that is, points P′₁, P′₂ and P′₃ respectively through the aforementioned method. By arranging a plurality of rods and their fixed hinge supports, the external thermal stress amplitude value can be further reduced compared with the case of only one rod.

Furthermore, in the above embodiment, a case that an end of the rod 100 is hinged to the object M and the other end is supported on the fixed hinge support 200 is described as an instance, but a support manner of the rod 100 is not limited to this. For example, the fixed hinge support 200 may be replaced with another constraint such as a weak spring, and alternatively, an end of the rod 100 may be rigidly connected to the object M. In other words, in a case that an end of the rod is connected to an object, and the other end is disposed within the scope of the disclosure by means of the support, an effect of reducing the external thermal stress can be achieved.

It should be noted that in the above description, since a material, shape, structure, etc. of the object M are not mentioned, the support method using a rod according to the disclosure is applicable to any structure subjected to external thermal stress.

Although the present disclosure has been described above with reference to the embodiments, it should be understood by those skilled in the art that the present disclosure is not limited to the embodiments described above, and various modifications can be made to the embodiments described above without departing from the spirit of the disclosure.

### DESCRIPTION OF REFERENCE NUMERALS

M Object before temperature change
M′ Object after temperature change
100 Rod
200 Support
Pᵢ Pre-temperature change position
P′ᵢ Post-temperature change position
Pᵢa Projection point

1. A support method of a support structure, comprising:
arranging a connection point on a supported body,
arranging an end of a rod at the connection point, arranging the other end at a support, and
selecting a position of the support according to the following relation:
as for a projection point (Pia) perpendicularly projected from the support (200) onto a line connecting a pre-temperature change position (Pi) and a post-temperature change position (P′i) of the connection point, a ratio (Δa/Δ) of a distance (Δa) between the pre-temperature change position (Pi) and the projection point (Pia) to a distance (A) between the pre-temperature change position (Pi) and the post-temperature change position (P′i) falls within a predetermined range.

2. The support method of a support structure according to claim 1, wherein the predetermined range is greater than or equal to −0.4 and less than or equal to 1.4.

3. The support method of a support structure according to claim 2, wherein the predetermined range is greater than or equal to 0 and less than or equal to 1.

4. The support method of a support structure according to claim 3, wherein the predetermined range is greater than or equal to 0.21 and less than or equal to 0.62.

5. The support method of a support structure according to claim 1, wherein an end of the rod (100) is hinged to the connection point.

6. The support method of a support structure according to claim 1, wherein the support (200) is a fixed hinged support.

7. A support structure, comprising a rod and a support, wherein a connection point is arranged on a supported body, an end of the rod is connected to the connection point, the other end is supported on the support, and arranged positions of the support satisfy the following relation:
as for a projection point (Pia) perpendicularly projected from the support (200) onto a line connecting a pre-temperature change position (Pi) and a post-temperature change position (P′i) of the connection point, a ratio (Δa/Δ) of a distance (Δa) between the pre-temperature change position (Pi) and the projection point (Pia) to a distance (A) between the pre-temperature change position (Pi) and the post-temperature change position (P′i) falls within a predetermined range.

8. The support structure according to claim 7, wherein the predetermined range is greater than or equal to −0.4 and less than or equal to 1.4.

9. The support structure according to claim 8, wherein the predetermined range is greater than or equal to 0 and less than or equal to 1.

10. The support structure according to claim 9, wherein the predetermined range is greater than or equal to 0.21 and less than or equal to 0.62.

11. The support structure according to claim 7, wherein an end of the rod (100) is hinged to the connection point.

12. The support structure according to claim 7, wherein the support (200) is a fixed hinged support.
